(19) United States
(12) Patent Application Publication
(10) Pub. No.: US 2026/0097731 A1
(43) Pub. Date: Apr. 9, 2026

(54) ENERGY ABSORBER FOR VEHICLE BUMPER

(71) Applicant: Ford Global Technologies, LLC, Dearborn, MI (US)

(72) Inventors: Mohammad Omar Faruque, Ann Arbor, MI (US); S.M. Iskander Farooq, Novi, MI (US)

(73) Assignee: Ford Global Technologies, LLC, Dearborn, MI (US)

(21) Appl. No.: 18/908,879

(22) Filed: Oct. 8, 2024

(51) Int. Cl. B60R 19/18

(52) U.S. Cl. CPC B60R 19/18; B60R 2019/186

(57) ABSTRACT

A bumper includes a crossbeam elongated along a vehicle-lateral axis. A fascia is vehicle forward of the bumper. The bumper includes an energy absorber supported on the crossbeam between the crossbeam and the fascia. The energy absorber includes deformable members arranged in a repeating pattern. Each deformable member includes a base segment and an extension segment. The base segment includes a base wall and side walls extending vehicle forward from the base wall to distal ends of the side walls. The base segment includes a V-shaped notch extending vehicle rearward from the distal ends of the side walls. The extension segment is disposed in the V-shaped notch and extends vehicle forward of the V-shaped notch to a distal end of the extension segment. The extension segment is compressible relative to the base segment.

### BACKGROUND

The desired stiffness of a vehicle bumper may be different depending on vehicle speed. For example, at a low vehicle speed, a higher stiffness may be desired to prevent damage to the bumper, while at a high vehicle speed, a lower stiffness may be desired during certain pedestrian and/or vehicle impacts.

Several vehicle research organizations release crash test standards for vehicles directed to specific outcomes. One example test is directed toward low-speed damageability (LSD), e.g., damage to vehicle components at relatively low speeds. However, as described above, the stiffness desired for the bumper system for LSD may differ from the stiffness desired for pedestrian kinematics including those at relatively higher speeds than LSD-type impacts. For example, other protocols for pedestrian leg impact may be benefited by a lower stiffness of the bumper in comparison to the stiffness desired for LSD. In other words, requirements for LSD and pedestrian kinematics may create competing design principles. There remains an opportunity to design a vehicle bumper that accounts for low speed damageability and pedestrian kinematics.

### BRIEF DESCRIPTION OF THE DRAWINGS

FIG. 1 is a perspective view of a portion of a vehicle including a bumper and a fascia.

FIG. 2 is a cross-sectional view of the bumper and the fascia.

FIG. 3 is a perspective view of deformable members of an energy absorber of the bumper

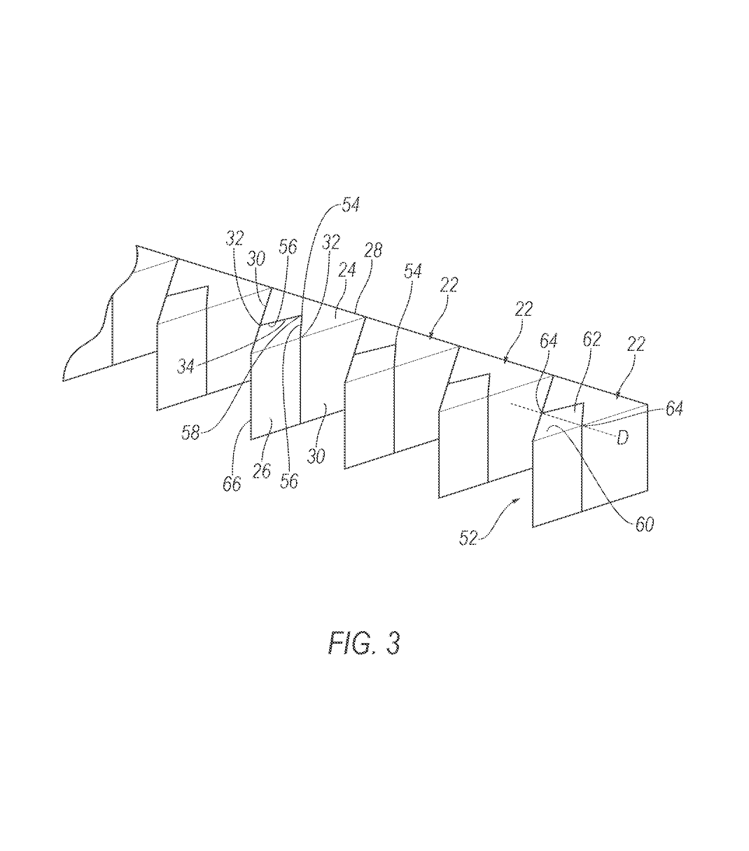

FIG. 4 is a side view of a vehicle during an example vehicle impact.

FIG. 5A is a cross-sectional view before impact in FIG. 4.

FIG. 5B is a cross-sectional view during impact.

FIG. 5C is a cross-sectional view during impact at a later time than FIG. 5B.

### DETAILED DESCRIPTION

With reference to the Figures, wherein like numerals indicate like parts throughout the several views a vehicle 10 includes a first frame rail 12 and a second frame rail 12 spaced from the first frame rail 12 along a vehicle-lateral axis A. The terms “first” and “second” are identifiers of the frame rails 12, and both the first and second frame rail 12 are identified with the same reference numeral. A bumper 14 includes a crossbeam 16 elongated along a vehicle-longitudinal axis L. The crossbeam 16 is supported by the first frame rail 12 and the second frame rail 12. A fascia 18 is vehicle forward of the bumper 14. The bumper 14 includes an energy absorber 20 supported on the crossbeam 16 between the crossbeam 16 and the fascia 18. The energy absorber 20 includes deformable members 22 arranged in a repeating pattern along the vehicle-lateral axis A. Each deformable member 22 includes a base segment 24 and an extension segment 26. The base segment 24 includes a base wall 28 elongated along the vehicle-lateral axis A. The base segment 24 includes side walls 30 extending vehicle forward from the base wall 28 to distal ends 32 of the side walls 30. The base segment 24 includes a V-shaped notch 34 extending vehicle rearward from the distal ends 32 of the side walls 30. The extension segment 26 is disposed in the V-shaped notch 34 and extends vehicle forward of the V-shaped notch 34 to a distal end 32 of the extension segment 26. The extension segment 26 is compressible relative to the base segment 24.

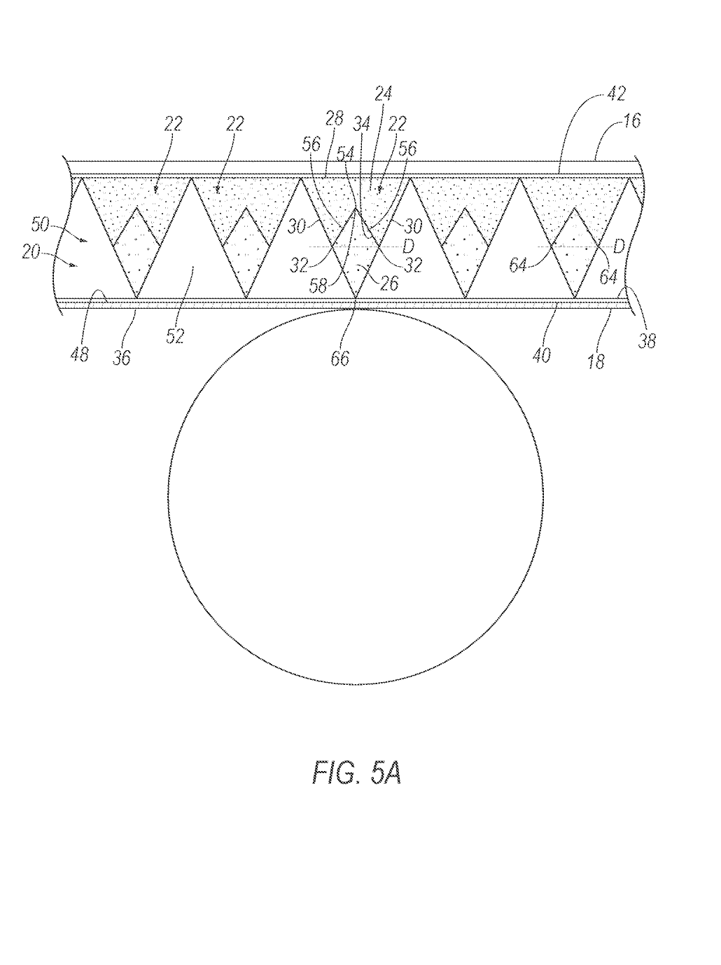

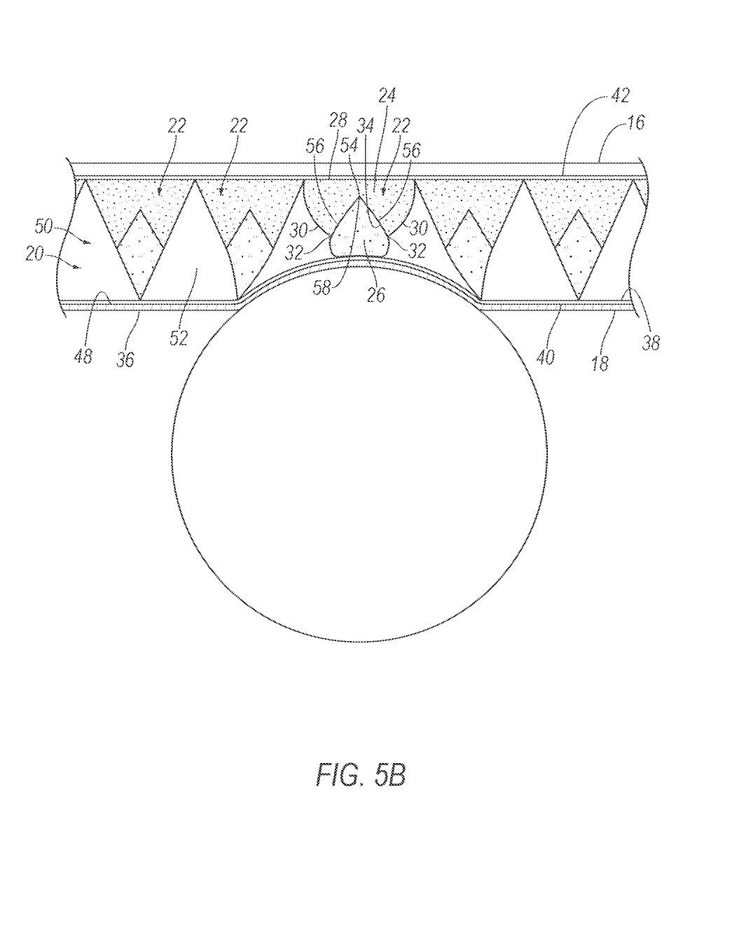

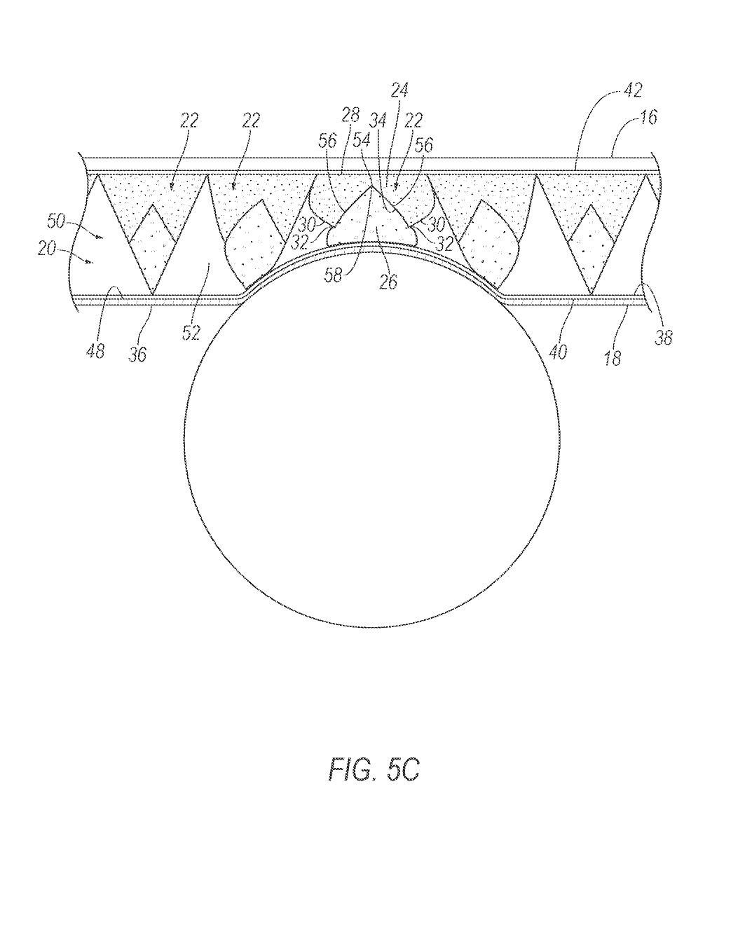

Since the extension segment 26 extends vehicle-forward of the V-shaped notch 34, the force on the energy absorber 20 during certain vehicle impacts is delivered to the extension segment 26 before the base segment 24. With reference to the progression shown in FIGS. 5A-5C, the extension segment 26 delivers the force to the base segment 24 at V-shaped notch 34. The V-shaped notch 34 distributes the force from the extension segment 26 to the base segment 24. Since the extension segment 26 is compressible relative to the base segment 24, a portion of the extension segment 26 that is forward of the base segment 24 may deform relative to the base segment 24. In the event the force is of sufficient magnitude, the force delivered from the extension segment 26 to the base segment 24 deforms the base segment 24. The dual-stiffness of the energy absorber 20 defined by the shape, position, orientation, and compressibility differences of the extension segment 26 and the base segment 24 provide performance both during low-speed impacts, e.g., those associated with low-speed damageability tests, and during high-speed impacts. This configuration also accommodates packaging constraints at the bumper 14 of the vehicle 10 to reduce constraints on vehicle size, shape, and styling.

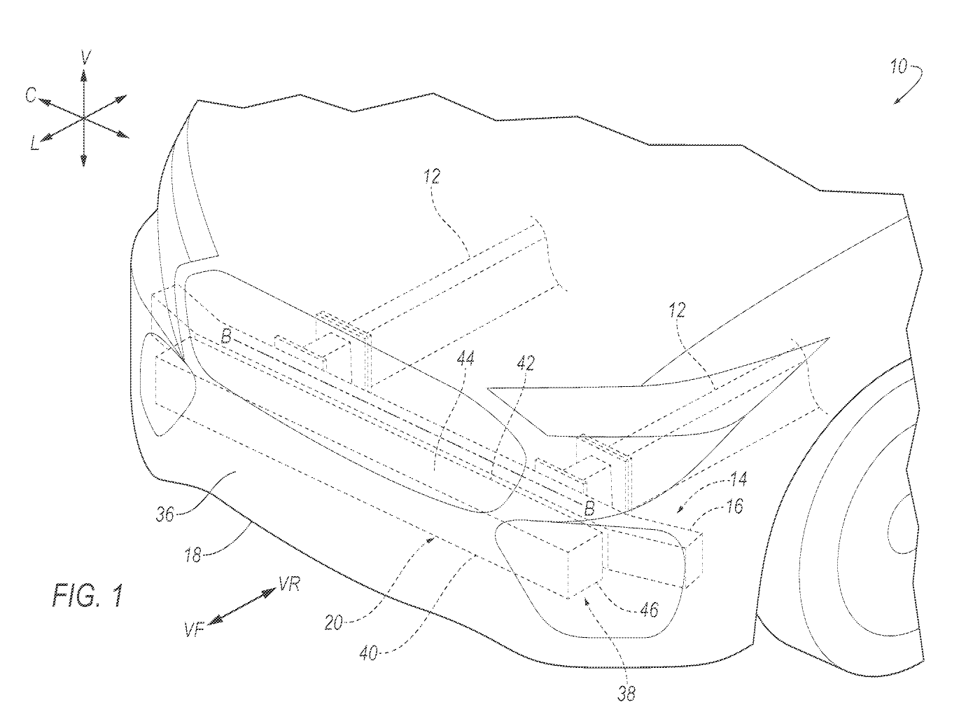

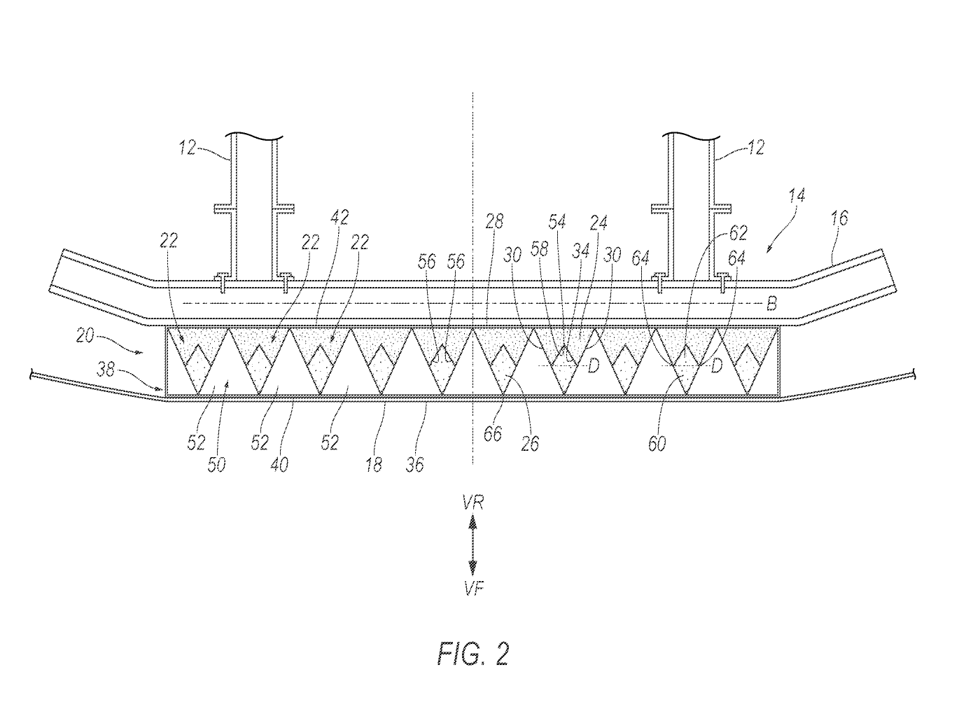

Relative vehicular orientations and directions by way of example, forward, rearward, top, bottom, front, rear, left, right, etc., are from the perspective of an occupant seated in the vehicle 10 and facing forward, e.g., toward a forward instrument panel and/or forward windshield of the vehicle 10. “Vehicle forward” is a parallel to direction of movement of the vehicle 10 when the vehicle 10 is engaged in forward drive with wheels of the vehicle 10 straight. “Vehicle rearward” is a direction opposite “vehicle forward.” In FIGS. 1 and 2, vehicle forward is identified with identifier VF and vehicle rearward is identified with identifier VR. Orientations and directions relative to the assembly are given related to when the assembly is supported by the vehicle 10 as described below and shown in the Figures. With reference to the bumper 14, “forward” and “rearward” are relative to the front and rear of the bumper 14. When the bumper 14 is mounted to the frame of the vehicle 10, “forward” and “rearward” are the same as “vehicle forward” and “vehicle rearward,” respectively.

The vehicle 10 defines a vehicle-longitudinal axis L that extends between a front and a rear of the vehicle 10. The vehicle 10 defines the vehicle-lateral axis A that extends between a left-side and a right-side of the vehicle 10. The vehicle 10 defines a vehicle-vertical axis V that extends between a top and a bottom of the vehicle 10. The vehicle-lateral axis A, the vehicle-longitudinal axis L, and the vehicle-vertical axis V are perpendicular relative to each other.

The vehicle includes a body (not numbered). The body and a frame of the vehicle 10 may be of a unibody construction. In the unibody construction, the body, e.g., rockers, pillars, roof rails, etc., serve as the frame, and the body (including the rockers, pillars, roof rails, etc.) is a unit. As another example, the body and frame may have a body-on-frame construction (also referred to as a cab-on-frame construction). In such an example, the body and frame are separate components, i.e., are modular, and the body is supported on and affixed to the frame. In other examples, the body and frame may have any suitable construction. The body and/or the frame may be any suitable material, for example, steel, aluminum, etc.

The body includes body panels (not numbered). The body panels may include structural panels, e.g., rockers, pillars, roof rails, etc. The body panels may include exterior panels. The exterior panels may present a class-A surface, i.e., a finished surface exposed to view by a customer and specifically manufactured to have a high-quality, finished aesthetic appearance free of unaesthetic blemishes and defects. The body panels include, e.g., facias (e.g., fascia 18 described below), a roof panel, door panels, fenders, hood, a decklid, etc. The vehicle body defines an occupant compartment to house occupants of the vehicle 10.

The vehicle frame includes the first frame rail 12 and the second frame rail 12. The vehicle frame may include cross beams extending cross-vehicle from the first frame rail 12 to the second frame rail 12. The first frame rail 12 and the second frame rail 12 are elongated along the vehicle-longitudinal axis L. The first frame rail 12 and the second frame rail 12 are spaced from each other cross-vehicle, i.e., along the vehicle-lateral axis A.

With continued reference to FIG. 1, the first frame rail 12 and the second frame rail 12 may define the cross-vehicle boundaries of the vehicle frame. The first frame rail 12 and the second frame rail 12 may be elongated along the vehicle-longitudinal axis L from a rear end of the vehicle 10 to a front end of the vehicle 10. In some examples, the first frame rail 12 and the second frame rail 12 may extend along substantially the entire length of the vehicle 10. In other examples, the first frame rail 12 and the second frame rail 12 may be segmented and extend under portions of the vehicle 10, e.g., at least extending from below an occupant compartment of the vehicle 10 to the front end of the vehicle 10. In some examples, the first frame rail 12 and the second frame rail 12 each may be unitary from the rear end of the vehicle 10 to the front end of the vehicle 10. In other examples, the first frame rail 12 and the second frame rail 12, respectively, may each include segments fixed to each other (e.g., by welding, threaded fastener, etc.) and in combination extending from the rear end of the vehicle 10 to the front end of the vehicle 10. The first frame rail 12 and the second frame rail 12 and/or the bumper 14 may include crush cans at the front end of the vehicle 10, as shown in the example in the Figures. In such examples, the crush cans may directly support the bumper 14 on the frame rails 12. For example, the bumper 14 may abut the crush cans and the weight of the bumper 14 may be borne by the crush cans, as shown in the example in the Figures.

As set forth above, the vehicle frame may have a body-on-frame construction in which the vehicle body is supported on and affixed to the vehicle frame. In such an example, the first frame rail 12 and the second frame rail 12 may each include cab mount brackets (not shown) on which the vehicle body is supported and affixed. The cab mount brackets are fixed to the first frame rail 12 and the second frame rail 12, e.g., welded to the first frame rail 12 and the second frame rail 12. The cab mount brackets may extend outboard from the respective first frame rail 12 and the second frame rail 12. The cab mount bracket may be cantilevered from the respective first frame rail 12 and the second frame rail 12. The cab mount brackets are configured to support the vehicle body in a body-on-frame configuration. For example, the cab mount brackets may include a post or a hole that receives a hole or a post, respectively, of the vehicle body to connect the vehicle body to the vehicle frame. Specifically, the vehicle body may be fixed to the cab mount brackets. During assembly of the vehicle 10, the vehicle body is set on the vehicle frame with fastening features of the vehicle body aligned with the cab mount brackets for engagement with the cab mount brackets.

The vehicle frame may include suspension and steering attachment points that support suspension and steering components of the vehicle 10. As one example, the suspension and steering attachment points may be suspension towers. Suspension and steering components of the vehicle 10 are connected to the vehicle frame, at least in part, at the suspension towers. The suspension and steering components include suspension shocks, suspension struts, steering arms, steering knuckles, vehicle 10 wheels, etc.

With reference to FIG. 1, the vehicle 10 has a front-end structure. The front-end structure includes the bumper 14 and the fascia 18 and may include a grill. The grill is above the bumper 14. The grill may be a component of the vehicle body and may be supported on other components of the vehicle body.

The fascia 18 is an exterior body panel of the vehicle body and is vehicle-forward of the bumper 14. The bumper 14 is between the fascia 18 and the crossbeam 16 of the bumper 14. The fascia 18 provides an aesthetic covering to the bumper 14. Specifically, the fascia 18 has an exterior surface 36 that is a class-A surface, i.e., a finished surface exposed to view by a customer and free of unaesthetic blemishes and defects. In some examples, the fascia 18 may be elongated along the cross-vehicle axis A. The fascia 18 may be supported by the frame of the vehicle 10 and/or other components of the body of the vehicle 10.

The fascia 18 and the bumper 14 are designed to manage energy during high-speed vehicle impacts and during low-speed vehicle impacts. For example, a high-speed impact test may be a high-speed pedestrian impact test that simulates an impact between the leg of a pedestrian and the vehicle 10. Such tests may, for example, use a legform, which is a test device including a plurality of sensors (not shown) designed to simulate a human leg. The bumper 14 assembly may absorb energy during a low speed vehicle impact test. A low-speed vehicle impact test may be a low-speed damageability test. The fascia 18 may be metal (e.g., steel, aluminum, etc.) or may be polymeric (e.g., plastic, composite, SMC, etc.).

The bumper 14 is connected to the vehicle frame. Specifically, the bumper 14 is connected to the vehicle frame. The bumper 14 may be connected to the first frame rail 12 and the second frame rail 12. Specifically, in such an example, the frame rail 12s are elongated along the vehicle-longitudinal axis L and the bumper 14 extends transversely to the frame rail 12s, e.g., along the cross-vehicle axis A. The bumper 14, for example, may be connected directly to the vehicle frame and by any suitable way including fasteners, welding, etc. The bumper 14 is supported by the vehicle frame, i.e., the weight of the bumper 14 is borne by the vehicle frame. The bumper 14 is a front bumper 14 in the example shown in the Figures. In other words, the bumper 14 is at a front of the vehicle 10. In another example, the bumper 14 may be a rear bumper 14 assembly, i.e., the bumper 14 may be at a rear of the vehicle 10.

The bumper 14 includes the crossbeam 16. The crossbeam 16 is elongated along the vehicle-lateral axis A, i.e., the longest dimension of the crossbeam 16 is along the vehicle-lateral axis A in such examples. The crossbeam 16 includes a longitudinal axis B that may be parallel to the vehicle-lateral axis A. The longest dimension of the crossbeam 16 is along the longitudinal axis B of the crossbeam 16. The crossbeam 16 may be supported by the vehicle frame 10, i.e., the weight of the crossbeam 16 may be borne by the vehicle frame (for example, by the first frame rail 12 and the second frame rail 12, as shown in the example in the Figures). The crossbeam 16 may be directly supported by the vehicle frame, and specifically the first frame rail 12 and the second frame rail 12, i.e., with no intermediate components between the crossbeam 16 and the first and second frame rails 12. The crossbeam 16 may be fixed to the first frame rail 12 and the second frame rail 12, e.g., via fastener, weld, etc. The crossbeam 16 may be directly fixed to the first frame rail 12 and the second frame rail 12, i.e., with no intermediate components between the crossbeam 16 and the first frame rail 12 and the second frame rail 12. For example, as shown in the example in the Figures, the crossbeam 16 may be supported directly by and fixed directly to the crush cans of the first frame rail 12 and the second frame rail 12, as described in the example set forth above. The crossbeam 16 may be any suitable material, for example, steel, aluminum, etc.

The energy absorber 20 of the bumper 14 is supported on the crossbeam 16 of the bumper 14, i.e., the weight of the energy absorber 20 is borne by the crossbeam 16. The energy absorber 20 may be connected directly to the crossbeam 16, e.g. by fasteners, welding, adhesive, bonding, etc. In such an example, the energy absorber 20 abuts the crossbeam 16. The energy absorber 20 is between the crossbeam 16 and the fascia 18.

The energy absorber 20 includes a casing 38 and deformable members 22 arranged in a repeating pattern in the casing 38. The casing 38 is connected to the crossbeam 16 and the casing 38 supports the deformable members 22 on the crossbeam 16. In other words, the weight of the deformable members 22 is borne by the casing 38 on the crossbeam 16. The casing 38 may be, for example, metal (e.g., steel, aluminum, etc.) or may be polymeric (e.g., plastic, composite, SMC, etc.). The casing 38 may have relatively thin walls. As an example, the casing 38 may have a forward wall 40, rearward wall 42, top wall 44, and bottom wall 46 enclosing the deformable members 22 about an axis of the deformable members 22 parallel with the longitudinal axis of the crossbeam 16. The forward wall 40 is vehicle-forward when assembled to the frame of the vehicle 10, i.e., may be referred to as a vehicle-forward wall 40. The rearward wall 42 is vehicle-rearward when assembled to the frame of the vehicle 10, i.e., may be referred to as a vehicle-rearward wall 42. In some examples, the forward wall 40 may abut the fascia 18, i.e., an inner surface 48 of the fascia 18. The forward wall 40 of the casing 38 may match at least some of the contours of the fascia 18. In some examples, the rearward wall 42 may abut the crossbeam 16, specifically a front surface of the crossbeam 16. The rearward wall 42 of the casing 38 may match at least some of the contours of the crossbeam 16. In some examples, the casing 38 may include end walls across the forward wall 40, rearward wall 42, top wall 44, and bottom wall 46 to entirely enclose the deformable members 22. When assembled to the frame of the vehicle 10, the rearward wall 42 is proximal to the crossbeam 16 and the forward wall 40 is distal to the crossbeam 16.

The casing 38 defines a cavity 50 and the deformable members 22 are disposed in the cavity 50. In some examples, the cavity 50 may house only the deformable members 22 and may otherwise be empty, i.e., unoccupied by anything other than air. The cavity 50 is defined by walls of the casing 38, e.g., the front wall, rear wall, top wall 44, and bottom wall 46.

The deformable members 22 are supported by the casing 38. As an example, one or more of the deformable members 22 may be connected to the casing 38, e.g., by threaded fastener, adhesive, bonding, etc. The deformable members 22 are arranged in a repeating pattern along the vehicle-lateral axis. For example, each of the deformable members 22 are arranged one-by-one adjacent each other along the longitudinal axis B of the crossbeam 16, e.g., along the vehicle-lateral axis A. In some examples, including the examples shown in the Figures, the deformable members 22 may be identical to each other in shape, size, and material type. In the example shown in the Figures, each deformable member 22 abuts an adjacent one of the deformable members 22. In the example shown in the Figures, adjacent ones of the deformable members 22 define a V-shaped gap 52 between the adjacent ones of the deformable members 22. The V-shaped gap 52 may be empty, i.e., unoccupied by anything except air.

Each deformable member 22 includes a base segment 24 and an extension segment 26. The base wall 28 of the base segment 24 of each deformable member 22 abuts the base wall 28 of the base segment 24 of an adjacent one of the deformable members 22. In some examples, the base segments 24 may be unitary with each other. In such examples, the base segments 24 may all be uniform piece of material with no seams, joints, fasteners, or adhesives holding the base segments 24 together, i.e., the base segments 24 are formed together simultaneously as a single continuous unit, e.g., by molding as one piece, machining from a unitary blank, forging, casting, etc. In other examples, the base segments 24 may be formed separately and subsequently assembled together, e.g., by attachment to the casing 38.

The base wall 28 of each base segment 24 is elongated along the longitudinal axis B, e.g., the vehicle-lateral axis A. In other words, the longest dimension of the base wall 28 is along the longitudinal axis B. The base wall 28 may be planar, as is shown in the example in the Figures.

The base segment 24 includes side walls 30 extending forward from the base wall 28 to distal ends 32 of the side walls 30. The base wall 28 is adjacent to the crossbeam 16 and the distal ends 32 are forward of, e.g., vehicle forward of, the base wall 28 and the rearward wall 42 of the casing 38. The distal ends 32 are spaced from the base wall 28 and the rearward wall 42. The side walls 30 may be planar, as shown in the example in the Figures. The deformable member 22 tapers from the base wall 28 in the forward direction. Specifically, the side walls 30 of each deformable member 22 may extend forward from the base wall 28 toward each other without reaching each other.

The V-shaped notch 34 extends rearward, e.g., vehicle rearward, from the respective distal end 32. Specifically, the V-shaped notch 34 includes a vertex 54 that is rearward, e.g., vehicle rearward, of the distal ends 32. The base segment 24 includes interior walls 56 each extending rearward from the distal ends 32 to the vertex 54 of the V-shaped notch 34. During impact to the extension segment 26, the extension segment 26 distributes force to the interior wall 56, and the interior walls 56, by the nature of their size, shape, and angle, distribute the force to the base segment 24.

The base segment 24 extends from the vertex 54 of the V-shaped notch 34 to the base wall 28 of the base segment 24. In other words, material of the base segment 24 is disposed between the vertex 54 of the V-shaped notch 34 and the base wall 28. The thickness of the base segment 24 from the rearward vertex of the V-shaped notch 34 to the base wall 28 is designed to support the extension segment 26 during impact to the extension segment 26 in a rearward direction, as shown in the example in FIGS. 5A-5C.

The extension segment 26 is disposed in the V-shaped notch 34 and extends vehicle forward of the V-shaped notch 34 to a distal end 32 of the extension segment 26. In some examples, including the examples shown in the Figures, the extension segments 26 each have a diamond shape. A portion of the diamond shape may match the shape of the V-shaped notch 34 so that extension segment 26 fills the entire V-shaped notch 34. The extension segment 26 may abut the interior walls 56 of the base segment 24 continuously from the distal ends 32 to the vertex 54 of the V-shaped notch 34. As shown in the example shown in the Figures, the diamond shape has a rearward vertex 58, e.g., a vehicle-rearward vertex, abutting the vertex 54 of the V-shaped notch 34.

The diamond shape has a forward portion 60, e.g., a vehicle-forward portion 60, and a rearward portion 62, i.e., a vehicle-rearward portion 62, meeting at opposing vertices 64. The opposing vertices 64 are vertices of the diamond shape that are spaced from each other across the interior of the diamond shape. In some examples, including the example shown in the Figures, the opposing vertices 64 are at the distal end 32 of the side walls 30 of the base segment 24. In such an example, a line D through the vertices of the diamond shape extends through the distal ends 32 of the base segment 24. In such examples, the forward portion 60 of the diamond shape has forward walls 40, e.g., vehicle-forward walls 40, each extending from a respective one of the distal ends 32 of the side walls 30 to a forward vertex 66, e.g., a vehicle-forward vertex, of the diamond shape. The forward walls 40 of the diamond shape are coplanar with the side walls 30 of the base segment 24, respectively, in the example shown in the Figures.

The line D divides the diamond shape between the forward portion 60 and the rearward portion 62. The forward portion 60 of the diamond shape may be larger than the rearward portion 62 of the diamond shape. Specifically, in the example shown in the Figures, the distance from the line D to the forward vertex 66 is greater than the distance from the line D to the vehicle-rearward vertex.

The vertices 54, 58, 64, 66 of the base segment 24 and the extension segment 26 may be elongated generally vertically. In other words, the longest dimension of each vertex 54, 58, 64, 66 is generally vertical. The vertices 54, 58, 64, 66 may be elongated along parallel lines.

The extension segment 26 is compressible relative to the base segment 24. In other words, upon application of force to the extension segment 26, e.g., a rearward force on the forward vertex 66 of the extension segment 26, the extension segment 26 compresses before the base segment 24 compresses. As an example, the material property of the extension segment 26 and the base segment 24 may be such that the extension segment 26 is compressible relative to the base segment 24. In other words, the material of the extension segment 26 may have a Young’s modulus that is lower than the Young’s modulus of the base segment 24.

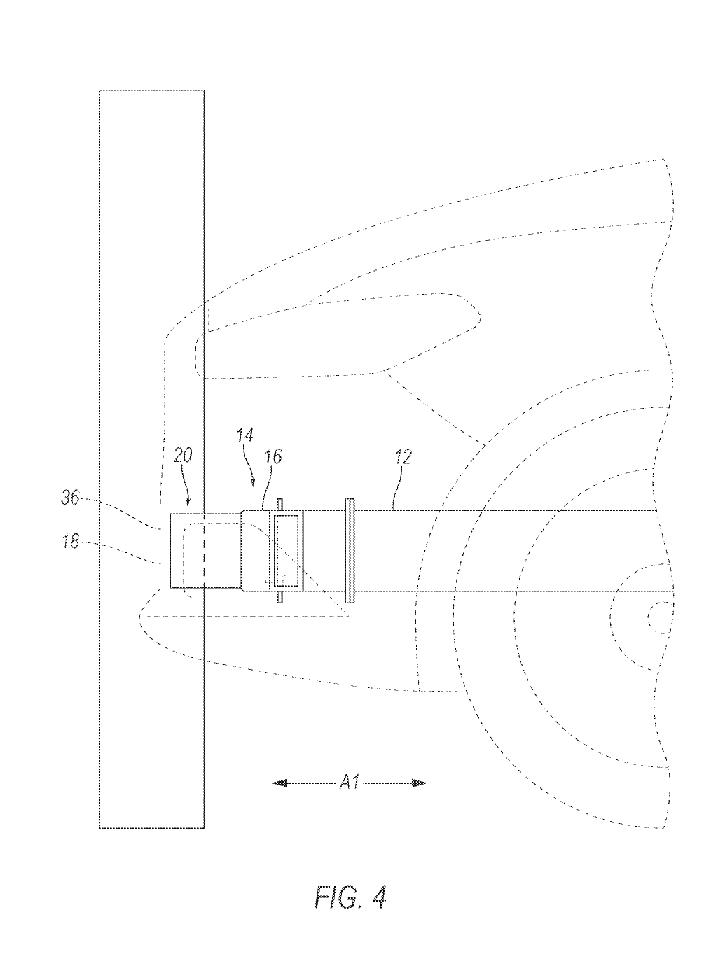

The extension segment 26 and/or the base segment 24 may be polymeric. As an example, the extension segment 26 and/or the base segment 24 may be a polymeric elastomer, i.e., a natural or synthetic polymer that has elastic properties. For example, the extension segment 26 and/or the base segment 24 may be polyurethane. In some examples, the extension segment 26 and/or the base segment 24 may be foam, e.g., polyurethane foam. In some examples, the extension segment 26 and/or the base segment 24 may be solid polyurethane (i.e., not foamed”). As other examples, the extension segment 26 and/or the base segment 24 may be rubber. The extension segment 26 and the base segment 24 are of a material that deforms before breakage or without breakage during impacts as shown in FIGS. 4-5C.

As shown in the example in the Figures, in some examples, the deformable members 22 may abut both the rearward wall 42 and the forward wall 40 of the casing 38. Specifically, the base segments 24 of the deformable members 22 abut the rearward wall 42, and the forward segments of the deformable members 22 abut the forward wall 40. In such an example, the deformable members 22 reinforce the casing 38 between the forward wall 40 and the rearward wall 42 to deliver force through the energy absorber 20 from the casing 38 to the crossbeam 16.

FIGS. 5A-5C show a progression of the application of force F to the energy absorber 20 in FIG. 4. As an example, FIGS. 4-5C show the progression of impact with an object, e.g., a legform, in a high-speed impact test. FIG. 5A shows the object prior to impact with the energy absorber 20. FIG. 5B shows a further progression of the impact after the object has deformed the forward wall 40 of the casing 38, delivering force to extension segments 26. The extension segment 26 receiving the direct impact of the force both deforms and delivers force to the base segment 24. Specifically, the forward vertex 66 of the extension segment 26 is compressed rearward and the forward walls 40 bulge. The rearward portion 62 bulges against the interior walls 56 of the base segment 24 and the vertex 54 of the V-shaped notch 34. The interior walls 56 may deform to distribute the force into the base segment 24. The side walls 30 of the base segment 24 bulge when force is applied to the interior walls 56 by the rearward portion 62. The base segment 24 delivers force to the rearward wall 42 of the casing 38 and the crossbeam 16. FIG. 5C shows a further progression of the impact. As shown in FIG. 5C, the forward portion 60 of the extension segment 26 further bulges and the rearward portion 62 of the extension segment 26 further deforms the interior walls 56 of the base segment 24. The interior walls 56 distribute the force into the base segment 24 and the side walls 30 of the base segment 24 bulge. Specifically, in FIG. 5C, the side walls 30 of the base segment 24 deform into and abut the side walls 30 of adjacent ones of the deformable members 22. In examples in which the object impacting the energy absorber 20 simultaneously impacts multiple deformable members 22, the side walls 30 of adjacent ones of the base segments 24 may bulge toward each other. This abutment of the side walls 30 increases the stiffness (i.e., decreases the compressibility) of the base portions and delivers force to the rearward wall 42 of the casing 38 and the crossbeam 16.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

What is claimed is:

1. A vehicle, comprising:
a first frame rail and a second frame rail spaced from the first frame rail along a vehicle-lateral axis;
a bumper including a crossbeam elongated along a vehicle-lateral axis, the crossbeam being supported by the first frame rail and the second frame rail; and
a fascia vehicle forward of the bumper;
the bumper including an energy absorber supported on the crossbeam between the crossbeam and the fascia;
the energy absorber including deformable members arranged in a repeating pattern along the vehicle-lateral axis, each deformable member including a base segment and an extension segment;
the base segment including a base wall elongated along the vehicle-lateral axis;
the base segment including side walls extending vehicle forward from the base wall to distal ends of the side walls;
the base segment including a V-shaped notch extending vehicle rearward from the distal ends of the side walls;
the extension segment being disposed in the V-shaped notch and extending vehicle forward of the V-shaped notch to a distal end of the extension segment; and
the extension segment being compressible relative to the base segment.

2. The vehicle as set forth in claim 1, wherein the extension segments each have a diamond shape.

3. The vehicle as set forth in claim 2, wherein, for each deformable member, the diamond shape has a vehicle-forward portion and a vehicle-rearward portion meeting at opposing vertices, the opposing vertices being at the distal end of the side walls of the base segment.

4. The vehicle as set forth in claim 3, wherein, for each deformable member, the diamond shape has a line extending through the opposing vertices, the vehicle-rearward portion of the diamond shape has a vehicle-rearward vertex, and the vehicle-forward portion of the diamond shape has a vehicle-forward vertex, the distance from the line to the vehicle-forward vertex being greater than the distance from the line to the vehicle-rearward vertex.

5. The vehicle as set forth in claim 3, wherein, for each deformable member, the vehicle-forward portion of the diamond shape has vehicle-forward walls each extending from a respective one of the distal ends of the side walls to a vehicle-forward vertex of the diamond shape, vehicle-forward walls of the diamond shape being coplanar with the side walls of the base segment, respectively.

6. The vehicle as set forth in claim 5, wherein adjacent ones of the deformable members define a V-shaped gap between the adjacent ones of the deformable members.

7. The vehicle as set forth in claim 2, wherein, for each deformable member, the V-shaped notch includes a vehicle-rearward vertex and the diamond shape has a vehicle-rearward vertex abutting the vehicle-rearward vertex of the V-shaped notch.

8. The vehicle as set forth in claim 7, wherein, for each deformable member, the base segment extends from the vehicle-rearward vertex of the V-shaped notch to the base wall of the base segment.

9. The vehicle as set forth in claim 1, wherein the base wall of the base segment of each deformable member is adjacent the crossbeam.

10. The vehicle as set forth in claim 1, wherein the base wall of the base segment of each deformable member abuts the base wall of the base segment of an adjacent one of the deformable members.

11. The vehicle as set forth in claim 1, wherein the energy absorber includes a casing defining a cavity that receives the deformable members.

12. The vehicle as set forth in claim 11, wherein the casing has a vehicle-rearward wall proximal to the crossbeam and a vehicle-forward wall distal to the crossbeam, the base segment of each deformable member abutting the vehicle-rearward wall, and the extension segment of each deformable member abutting the vehicle-forward wall.

13. The vehicle as set forth in claim 11, wherein the fascia abuts the casing.

14. A vehicle bumper, comprising:
a crossbeam elongated along a longitudinal axis; and
an energy absorber supported on the crossbeam and disposed in a forward direction;
the energy absorber including deformable members arranged in a repeating pattern along the longitudinal axis, each deformable member including a base segment and an extension segment;
the base segment including a base wall elongated along the longitudinal axis;
the base segment including side walls extending in the forward direction from the base wall to distal ends of the side walls;
the base segment including a V-shaped notch extending in a rearward direction opposite the forward direction from the distal ends of the side walls;
the extension segment being disposed in the V-shaped notch and extending vehicle forward of the V-shaped notch to a distal end of the extension segment; and
the extension segment being compressible relative to the base segment.

15. The vehicle bumper as set forth in claim 14, wherein the extension segments each have a diamond shape, and, for each deformable member, the diamond shape has a forward portion and a rearward portion meeting at opposing vertices, the opposing vertices being at the distal end of the side walls of the base segment.

16. The vehicle bumper as set forth in claim 15, wherein, for each deformable member, the forward portion of the diamond shape has forward walls each extending from a respective one of the distal ends of the side walls to a forward vertex of the diamond shape, forward walls of the diamond shape being coplanar with the side walls of the base segment, respectively.

17. The vehicle bumper as set forth in claim 15, wherein, for each deformable member, the V-shaped notch includes a rearward vertex and the diamond shape has a rearward vertex abutting the rearward vertex of the V-shaped notch, and the base segment extending from the rearward vertex of the V-shaped notch to the base wall of the base segment.

18. The vehicle bumper as set forth in claim 14, wherein the base wall of the base segment of each deformable member is adjacent the crossbeam.

19. The vehicle bumper as set forth in claim 14, wherein the energy absorber includes a casing defining a cavity that receives the deformable members.

20. The vehicle bumper as set forth in claim 19, wherein the casing has a rearward wall proximal to the crossbeam and a forward wall distal to the crossbeam, the base segment of each deformable member abutting the rearward wall, and the extension segment of each deformable member abutting the forward wall.
